(19) United States
(12) Patent Application Publication
(10) Pub. No.: US 2003/0121213 A1
(43) Pub. Date: Jul. 3, 2003

(54) Lapping medium and method of generating the same

(75) Inventors: Tsuyoshi Takizawa, Yaizu-shi (JP); Shinnichi Takahashi, Shizuoka-shi (JP); Yukio Okuyama, Yao-shi (JP); Takao Kaneko, Yaizu-shi (JP)

Correspondence Address: SUGHRUE MION, PLLC, 2100 Pennsylvania Avenue, NW, Washington, DC, 20037-3213, US

(73) Assignee: FJUI PHOTO FILM CO., LTD.

(21) Appl. No.: 10/246,758

(22) Filed: Sep. 19, 2002

(30) Foreign Application Priority Data
Sep. 20, 2001 (JP) 286307/2001

(51) Int. Cl. C09C 1/68

(52) U.S. Cl. 51/308

(57) ABSTRACT

A lapping medium comprising a supporting body and a lapping layer formed on the supporting body. The lapping layer includes an abrasive and a binder. The abrasive comprises silica grains, which are pretreated with at least one coupling agent selected from a group consisting of a silane coupling agent, a titanate coupling agent, and an aluminum-contained coupling agent, and a binder.

### BACKGROUND OF THE INVENTION

1. Field of the Invention

The present invention relates to a lapping medium, such as a lapping sheet, a lapping disk, etc., which is employed in finishing the lapping of the ferrule end face of an optical fiber connector, and to a method of generating the lapping medium.

2. Description of the Related Art

Optical fiber connectors are used to connect two optical fibers together. The connecting end portion of an optical fiber is covered with a ferrule, which is formed from a ceramic material such as zirconia, etc. The ferrule end face and the optical fiber end face of the end of an optical fiber connector are mirror finished and two optical fiber connector ends are brought into direct contact with each other and connected by the use of a jig. In optical communications, the optical fiber connectors are in wide use because they are easy to handle.

In the mirror finish of the ferrule end face of an optical fiber connector, a plurality of lapping steps from rough lapping to finish lapping are performed while reducing the grain size of an abrasive in sequence. In optical fiber connectors, lapping accuracy and optical characteristics are of importance because light passes through optical fibers. The accuracy of finish lapping is especially important since it has influence on optical characteristics. If the ferrule end face of an optical fiber connector, particularly the smoothness (mirror degree) of the optical fiber is insufficient, good optical characteristics cannot be obtained and return loss (light loss rate) will increase. If a great difference in level occurs between the end face of the optical fiber and the end face of the ferrule which are different materials, or lapping scores occur in the fiber end face, durability as well as optical characteristics will be degraded.

In a conventional method of lapping the end face of an optical fiber connector, the connector end face is first pressed against a sheet with or without a lapping layer. When the connector end face is slid against the sheet, a lapping solution with abrasive grains (diamonds or silica) dispersed therein is supplied to the connector end face to be lapped. In this manner, lapping of the fiber connector end is performed. However, in the case where a lapping solution is used, the problem of a fluctuation in concentration of the lapping solution, uneven wear due to a standing solution, adhesion of an abrasive to an end face, etc., will occur easily. This problem has influence on the optical characteristics (return loss, mirror degree, etc.) of the end face lapped and also increases the difference in level between the optical fiber end face and the ferrule end face.

Another finish lapping is disclosed in Japanese Unexamined Patent Publication No. 8(1996)-336758. Using a lapping medium that has a lapping layer with an abrasive (alumina, silica, etc.,), the end face of an optical fiber connector is lapped only with the lapping force of the lapping layer. In this method, no lapping solution is used, therefore overcoming the aforementioned problem.

The above-described lapping medium has a lapping layer, which includes abrasive grains and a binding agent and is formed on a supporting body. Depending on the lapping accuracy required of an optical fiber, a lapping medium with a lapping layer different in surface roughness is used. The abrasive grains have a Moh's hardness of 6 or greater and consist, for example, of chromium oxide, alumina, diamond, etc. A lapping medium for finish lapping has an abrasive whose grain size is small so that lapping can be performed with target accuracy.

Furthermore, Japanese Unexamined Patent Publication Nos. 11(1999)-333731 and 11(1999)-333732 disclose a lapping medium, in which fine grooves are formed in a lapping layer which includes silica grains (abrasive). The fine grooves are provided for the purposes of collecting grinding shavings, preventing grinding scores, and maintaining grinding force.

The above-described lapping media, however, have the disadvantage that the abrasive grains will produce a secondary aggregate and will not be dispersed uniformly to the binder. Because of a secondary aggregate and poor dispersion of an abrasive, there is a problem that lapping scores will occur in an end face lapped.

To overcome the above-described problems, it is effective to reduce the ratio of an abrasive. However, if the ratio is reduced, the quantity of an abrasive per unit volume will be reduced and therefore uniform lapping will become difficult. As a result, the flatness and mirror degree of an optical fiber end face lapped are insufficient, the optical characteristics are reduced, the return loss increases, and the difference in level and lapping scores are increased.

### SUMMARY OF THE INVENTION

The present invention has been made in view of the problems found in the prior art. Accordingly, it is an object of the present invention to provide a lapping medium that is capable of performing lapping without employing a lapping solution in the finish lapping of an optical fiber connector. Another object of the invention is to provide a lapping medium which is capable of uniformly dispersing abrasive grains and thereby enhancing the optical characteristics of an end face lapped without increasing the ratio of a binder.

To achieve the aforementioned objects of the present invention, there is provided a lapping medium comprising a supporting body and a lapping layer formed on the supporting body. The lapping layer includes an abrasive and a binder. The abrasive comprises silica grains, which are pretreated with at least one coupling agent selected from a group consisting of a silane coupling agent, a titanate coupling agent, and an aluminum coupling agent. The lapping medium of the present invention is particularly suitable to lap the end face of an optical fiber connector.

The above-described silane coupling agent generally has a chemical structure of R—Si—X₃, and it is desirable that it have an organic functional group R, which has a substituent which couples with organic materials, and a hydrolysis group X, which reacts with inorganic materials, in the same molecule. In the chemical structure, R is a vinyl group, a glycidoxy group, a methacrylic group, an amino group, a mercapto group, an epoxy group, etc., and X is mainly chlorine and an alkoxy group. The molecular weight is on the order of 140 to 260. In the above-described titanate coupling agent, Si in the silane coupling agent is replaced with Ti. In the above-described aluminum coupling agent (which is also called alkylacetoacetate)aluminum), Si in the silane coupling agent is replaced with Al.

In the lapping medium of the present invention, the above-described silica grains may have an average grain size of 0.005 to 3 μm. The above-described coupling agent may be in the range of 0.1 to 10 weight parts to 100 weight parts of the abrasive. The above-described binder may be in the range of 10 to 200 weight parts to 100 weight parts of the abrasive. The binder may also comprise a monomer or oligomer. Particularly, an ultraviolet-ray curing type monomer is preferred. The above-described lapping layer may have a worm-shaped low-concentration abrasive portion of 0.1 to 10 mm in length and 25 to 200 μm in breadth.

Further in accordance with the present invention, there is provided a method of generating a lapping medium, comprising the steps of:

preparing an abrasive comprising silica grains whose average grain size is 0.005 to 3 μm;

selecting at least one coupling agent from a group consisting of a silane coupling agent, a titanate coupling agent, and an aluminum-contained coupling agent;

adding the one coupling agent in the range of 0.1 to 10 weight parts to 100 weight parts of the abrasive;

preparing paint which has a mixture of the abrasive and a binder in the ratio of 100 to 200 weight parts to 100 weight parts of the abrasive and has a solid component of concentration 5 to 50 weight percent;

applying the paint to a supporting body;

drying the paint applied to the supporting body in the atmosphere of 100 to 130° C. and then irradiating ultraviolet rays to the dried paint to generate a lapping layer of 1 to 7 μm in thickness.

In the method of the present invention, the paint may be applied to the supporting body by a microgravure method, a commacoat method, or a Mayer Bar method.

According to the present invention, the abrasive of the lapping layer provided on the supporting body comprises silica grains, which are pretreated with at least one coupling agent selected from a group consisting of a silane coupling agent, a titanate coupling agent, and an aluminum-contained coupling agent. The abrasive treated with the coupling agent is dispersed uniformly to the binder, and curing is performed. Therefore, uniform dispersion of the abrasive into the binder, and complete coupling between the binder and the abrasive, are achieved. Therefore, the end face of an optical fiber connector can be lapped with a high degree of accuracy. The mirror finish of the lapped optical fiber end is good, and the optical characteristics of the fiber end are enhanced. The return loss (light loss rate) can be reduced to about −60 dB. Furthermore, the optical fiber portion of the connector end face lapped becomes convex, so a difference in level with the ferrule portion of the connector end face can be made smaller.

The aforementioned coupling agent serves as an adhesion improving agent at the interface between a binder (organic polymer) and an abrasive (inorganic substance). If fine abrasive grains such as colloidal silica are coupled by the coupling agent, the abrasive grains can be coupled with the molecule of the binder. Therefore, in the lapping medium of the present invention the abrasive can be taken into the molecule of the binder, although in a conventional lapping medium the abrasive is merely mixed with the binder. Therefore, the occurrence of lapping scores due to an abrasive aggregated or undispersed can be prevented. Because an abrasive can be bound with a binder reduced in quantity, lapping of the optical fiber end face and the ferrule end face of an optical fiber connector can be efficiently performed in a short time, and uniform lapping can be performed. Thus, the optical characteristics of the fiber connector end can be enhanced.

If the aforementioned abrasive comprises silica grains whose average grain size (D50) is 0.005 to 3 μm, a lapping layer is obtained which is superior in finish lapping characteristics.

If the above-described binder comprises an ultraviolet-ray curing type monomer and/or oligomer, the abrasive can be dispersed more uniformly into the binder, because the molecular weight of resin is typically 10000 or greater and the molecular weight of an oligomer is 1000 to 10000 and a monomer is the minimum compound of a high polymer. Particularly, in an ultraviolet-ray curing type, generation of a lapping layer can be easily performed by curing paint.

If the above-described lapping layer has a worm-shaped low-concentration abrasive portion of 0.1 to 10 mm in length and 25 to 200 μm in breadth, the lapping efficiency can be improved by the low-concentration abrasive portion. In addition, the end face of an optical fiber connector can be lapped with a high degree of accuracy and therefore the optical characteristics of the fiber end face can be enhanced.

### BRIEF DESCRIPTION OF THE DRAWINGS

The present invention will be described in further detail with reference to the accompanying drawings wherein:

FIG. 1 is a front view showing a lapping medium constructed in accordance with a preferred embodiment of the present invention.

### DESCRIPTION OF THE PREFERRED EMBODIMENT

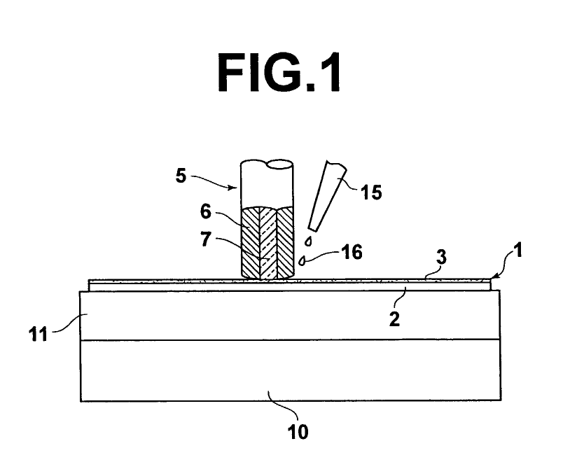

Referring now to FIG. 1, there is shown a lapping medium 1 constructed in accordance with a preferred embodiment of the present invention. The lapping medium 1 comprises a supporting body 2, and a lapping layer 3 stacked on the supporting body 2. The lapping layer 3 is formed, for example, to a thickness of 1 to 7 μm. The lapping medium 1 is formed, for instance, from a lapping disc sheet. The supporting body 2 is formed from polyester film, etc., and is 25 to 100 μm (e.g., 75 μm) in thickness. The lapping layer 3 includes an abrasive, and also includes a binder at the ratio of 10 to 200 weight parts to 100 weight parts of abrasive. The abrasive comprises silica grains whose average grain size (D50) is 0.005 to 3 μm (e.g., 0.012 μm), pretreated with at least one coupling agent (0.1 to 10 weight parts to 100 weight parts of abrasive) selected from a group consisting of a silane coupling agent, a titanate coupling agent, and an aluminum coupling agent. The binder includes, for example, an ultraviolet-ray curing type monomer and/or oligomer.

It is preferable that the lapping layer 3 have a worm-shaped low-concentration abrasive portion of 0.1 to 30 mm in length and 25 to 200 μm in width discontinuously in a normal-concentration abrasive portion which occupies the greater part of the surface. The surface of the normal-concentration abrasive portion is smooth (the center line average roughness Ra is 0.01 to 0.3 μm), while the low-concentration abrasive portion is formed into the shape of a groove.

In the process of applying lapping paint to the supporting body 2 and drying the lapping paint at 100 to 130° C. (e.g., 115° C.), the low-concentration abrasive portion is generated when the paint contracts. The low-concentration abrasive portion extends in the traveling direction of the supporting body 2 (film) and is formed. The low-concentration abrasive portion is thin at both ends and becomes gradually thicker toward the central portion. The low-concentration abrasive portion extends in straight-line form or meanders slightly, as a whole. The interior of the low-concentration abrasive portion is formed into a groove shape, having been split by being pulled from both sides, while the bottom has a groove/land pattern that extends in the direction of the width. The top surface is in the form of a worm. This low-concentration abrasive portion does not extend in a direction perpendicular to the above-described traveling direction and is independently formed discontinuously from a low-concentration abrasive portion adjacent in a lateral direction.

As shown in FIG. 1, an optical fiber connector 5 that is lapped by the lapping medium 1 has a ferrule 6, which is formed from a ceramic material such as zirconia. The optical fiber connector 5 further has an optical fiber 7. The optical fiber 7 is formed from a glass material such as quartz glass and is inserted into the center hole of the ferrule 6. The lapping medium 1 is mounted on an elastic body 11 such as rubber. The elastic body 11 is installed on a baseplate (rotating table) 10. When the end face of the optical fiber connector 5 is lapped, the tip of the connector 5 is pressed against the lapping medium 1 with a predetermined pressure. Then, the baseplate 10 is rotated at a predetermined speed and performs planetary rotation motion. Next, a supply nozzle 15 supplies a coolant solution (water) 16 to the tip of the connector 5 pressed against the lapping medium 1. In this manner, wet lapping is performed.

In the step of generating the lapping medium 1, a solvent, a coupling agent, and an abrasive are put into a disperser and are agitated. Then, a binder is put into the disperser and is dispersed to generate a paint in which the concentration of a solid component is 5 to 50 wt % (weight percent). This paint is applied to a predetermined thickness on the supporting body 2 being moved at a predetermined speed by an applicator which employs a microgravure method, a commacoat method, a Mayer Bar method, etc. In a drying device, the applied paint is dried in a heated atmosphere at 100 to 130° C. to form the lapping layer 3. In the drying step, the lapping layer 3 is provided with a worm-shaped low-concentration abrasive portion. Thereafter, the lapping layer 3 is formed into the lapping medium 1 by punching, cutting, etc.

The abrasive that is employed in the lapping layer 3 of the present invention is constructed of silica (SiO₂) grains, the average grain size of which is 0.005 to 3 μm. If the grain size of an abrasive is smaller, optical characteristics become better. However, the abrasive is less liable to be dispersed and the amount of binder must be increased. Mixture of the abrasive and the binder is performed in the range of binder 10 to 200 weight parts (preferably 25 to 150 weight parts) to 100 weight parts of abrasive.

The abrasive (silica grains) maybe Composite Spherical Silica (made by TOKUYAMA), AEROSIL (made by Nippon Aerosil), Nipsil (made by Nippon Silica Industrial Co.), SYLYSIA (made by Fuji Sylysia Chemical), or MIZUKASIL (made by MIZUSAWA INDUSTRIAL CHEMICALS), for example.

The binder in the lapping layer 3 of the present invention employs a monomer and/or an oligomer, particularly of an ultraviolet-ray curing type. However, it may contain known thermoplastic resin, thermosetting resin, reactive resin, electron beam curing resin, visible-ray curing resin, or a mixture of them.

The binder, which comprises a monomer or oligomer, has an average molecular weight of 10000 or less, preferably 1000 or less. An ultraviolet-ray curing type is superior in workability and easy to handle. An ultraviolet-ray curing type monomer or oligomer has, for example, one to a few acryloyl groups as the functional group, shows a radical polymerization reaction with a photopolymerization monomer by ultraviolet rays and polymerizes. Depending on the structure of a molecule constituting a skeleton, there are polyester acrylate, polyurethane acrylate, epoxy acrylate, polyether acrylate, oligo acrylate, alkyd acrylate, polyol acrylate, and so on. As a photopolymerization monomer, a monofunctional acrylate or multifunctional acrylate is employed. Typical examples of a monomer are diethyleneglycol diacrylate; neopentylglycol diacrylate; 1,6-hexandiol acrylate; trimethylolpropane triacrylate; pentaerythritol triacrylate; etc. Some of them require a photopolymerization initiator. Some examples, for instance, are benzoinethers such as isobutylbenzoinether; α-acyloxymuethers; benzylketals such as 2,2-dimetoxy-2-phenylacetophenone; acetophenone derivatives such as diethoxyacetophenone; ketones such as benzophenone, and ketone-amines.

More specifically, an epoxy ultraviolet-ray curing resin may employ Optomer (made by Adeka). An acrylic ultraviolet-ray curing resin may employ SEIKA-BEAM (made by DAINICHISEIKA COLOR & CHEMICALS). An acrylic silicon ultraviolet-ray curing resin may employ UVHC (made by GE Toshiba Silicon). Devices for irradiating ultraviolet rays are commercially available.

In addition to the above-described resins, there are the following materials. In preferred thermosetting resins or reactive resins, the molecular weight is 10000 or less in the state of a coating solution. If they are heated and wetted after application and drying, the molecular weight becomes infinitely large by a reaction such as condensation, addition, etc. Among these resins, preferred resins will not soften or melt until they are pyrolyzed. For instance, some examples are phenol resin, phenoxy resin, epoxy resin, polyurethane resin, polyester resin, polyurethane polycarbonate resin, urea resin, melamine resin, alkyd resin, silicon resin, acrylic reactive resin (electron-beam curing resin), epoxy-polyamide resin, nitrocellulosemelamine resin, a mixture of high-molecular polyester resin and an isocyanate prepolymer, a mixture of a methacrylate copolymer and a diisocyanate preploymer, a mixture of polyesterpolyol and polyisocyanate, urea formaldehyde resin, a mixture of low-molecular glycol/high-molecular weight diol/triphenylmethane triisocyanate, polyamine resin, polyimine resin, a mixture of them, and so on.

In addition to the main functional group, the above-described thermoplastic resin, thermosetting resin, and reactive resin have, as its functional group, an acid group such as carboxylic acid (COOM), sulfinic acid, sulfenic acid, sulfonic acid (SO₃M), phosphoric acid (PO(OM)(OM)), phosphonic acid, sulfuric acid (OSO₃M), and these ester groups (where M represents H, alkali metal, alkali earth metal, and a hydrocarbon radical); amino acids, amino sulfonic acids, sulfuric acid or phosphoric acid esters of amino alcohol, and an amphoteric group such as alkylbetaine types; an amino group; an imino group; an imide group; an amide group; a hydroxyl group, an alkoxyl group, a thiol group, an alkyltio group, a halogen group (F, Cl, Br, I), a siliro group, a siloxane group, an epoxy group, an isocyanate group, a cyano group, a nitryl group, an oxo group, an acrylic group, and a phosphine group.and so on. The above-described thermoplastic resin, thermosetting resin, and reactive resin also include one kind of functional group to 6 kinds of those. It is preferable that 1×10⁻⁶ eq to 1×10⁻² eq of each functional group is included per 1 gram of resin.

A coupling agent for an abrasive is preferably a compound that has, in the same molecule, both a hydrolysis group which reacts with an abrasive, which is an inorganic substance and a functional group which reacts with a monomer, which is an organic substance. Some examples are a silane coupling agent, a titanate coupling agent, an aluminate coupling agent, etc. If these coupling agents are used, an abrasive which is an inorganic substance can be coupled with a monomer which is an organic substance. As the properties of an organic substance can be applied to an inorganic substance, dispersion and adhesion can be greatly improved. An optimum coupling agent is selected by an inorganic substance and an organic substance that are used. In the present invention, a silane coupling agent or titanate coupling agent, which couples easily with silica grains, is preferred.

As described above, the silane coupling agent generally has a chemical structure of R—Si—X₃, and includes an organic functional group R, which has a substituent which couples with organic materials, and a hydrolysis group X, which reacts with inorganic materials, in the same molecule. In the chemical structure of R—Si—X₃, R is a vinyl group, a glycidoxy group, a methacrylic group, an amino group, a mercapto group, an epoxy group, etc., and X is mainly chlorine and an alkoxy group. The molecular weight is on the order of 140 to 260. In the titanate coupling agent, Si in a silane coupling agent is replaced with Ti. In the aluminum coupling agent, Si in a silane coupling agent is replaced with Al. Some examples are a silane coupling agent and a titanate coupling agent, generated by Shinetsu Silicon, Nippon Unicar, Toray Dow Corning, GE Toshiba Silicones, Nippon Soda, etc.

As necessary, the lapping layer 3 in the present invention may contain (1) a lubricating agent (in organic fine powder, resin fine powder, organic compounds, organic acid and organic acid ester compounds, fatty acid esters, fatty acid or fatty acid amides, fatty acid alkylamides, aliphatic alcohols, an antioxidant, etc.); (2) a dispersing agent or dispersion assisting agent for a lapping agent (fatty acid of carbon numbers 2 to 40, higher alcohol of carbon numbers 4 to 40, metal soap, fatty acid amide, sulfuric acid ester of them, etc.); (3) a mildew proofing agent (2-(4-thiazolyl)-benzimidazole; N-(fluorodichloromethylthio)-phthalimide; 10,10′-oxybisphenoxalcyne; 2,4,5-tetrachroloisophthalonitrile; trildiiodomethylsulfon; triiodoallylalcohol; dihydroxyaceto acid; phenyloleic acid mercury; bisu oxide (tributyl tin); salicyl anilide; etc.); (4) an antistatic agent (carbon black, conductive powder of titanium oxide-tin oxide-antimony oxide, etc., a natural surface active agent such as saponin, a nonionic surface active agent, a cationic surface active agent, an anionic surface active agent, an ampholytic surface active agent, etc.); and (5) a coupling agent. A lubricating agent that is used in the present invention is added in the range of 0.01 to 30 weight parts to 100 weight parts of binder.

An organic solvent that is used in dispersing, kneading, and coating the lapping paint of the present invention may comprise, at an arbitrary ratio, (1) ketones such as acetone, methylethylketone, methylisobutylketone, cyclohexanone, and isophorone; (2) alcohols such as methanol, ethanol, propanol, butanol, isobutylalcohol, isopropylalcohol (IPA), and methylcyclohexanol; (3) esters such as methyl acetate, ethyl acetate, butyl acetate, isobutyl acetate, isopropyl acetate, ethyl lactate, and glycolmonoethylether acetate; (4) ethers such as diethylether, tetrahydrofuran, glycoldiethylether, glycolmonoethylether, and dioxane; (5) tars (aromatic hydrocarbons) such as benzen, toluene, xylene, cresol, chlorobenzene, and styrene; and (6) chlorinated hydrocarbon such as methylene chloride, ethylene chloride, carbon tetrachloride, chloroform, ethylenechlorohydrin, and dichlorobenzene; N.N-dimethyl formaldehyde; hexane etc. In these solvents, one kind is normally used, but two or more kinds may be used as a mixture at an arbitrary ratio. A solvent may contain a slight quantity (1 wt % or less) of impurities (e.g., the polymer of the solvent itself, water, raw material components, etc.).

The method of dispersing and kneading the lapping paint of the present invention is not particularly limited. In addition, the adding order of components (resins, powder, lubricating agents, solvents, etc.), adding positions during dispersing and kneading, dispersing temperature (0 to 80° C.), etc., can be appropriately set. In the preparation of the lapping paint of the present invention, this embodiment may employ ordinary kneaders, for example, a two-roll mill, a three-roll mill, a ball mill, a pebble mill, a trommel, a paint shaker, a sand grinder, a Szegvari atolighter, a high-speed impeller disperser, a high-speed stone mill, a high-speed shock mill, a disperser, a kneader, a high-speed mixer, a ribbon blender, an intensive mixer, a tumbler, a blender, a homogenizer, a single-axis screw extruder, a two-axis screw extruder, and an ultrasonic disperser. Theses devices may employ steel balls, steel beads, ceramic beads, glass beads, and organic polymer beads to effectively accelerate the dispersion and kneading of the lapping paint of the present invention. The balls or beads are 10 cm to 0.05 mm in diameter. These materials are not limited to being of a spherical shape.

The material of the supporting body 2 may be any material as long as it has a flat surface to which paint can be applied. However, polyethylene terephthalate (PET) is preferred because it is of low-cost and easy to handle. The thickness is 25 to 100 μm, preferably 75 μm. To enhance adhesion between the supporting body 2 and the lapping layer 3, the supporting body 2 may undergo pretreatment, such as corona treatment, plasma treatment, EB treatment, easy-to-adhere layer application treatment, heat treatment, etc., before the lapping layer 3 is applied to the supporting body 2.

The above-described lapping layer 3 is applied on the supporting body 2. After being dried at 100 to 130° C., they are cured by an ultraviolet-ray irradiating machine and are rolled. The lapping medium 1 thus generated is cut into the desired shape. For further reference to the lapping agent, binding agent, additive agents (lubricating, dispersing, antistatic, and surface treatment agents), solvent, and supporting body (which may have a lower paint layer, a back layer, and a back lower paint layer) of the present invention and the method of generation, see the lapping-tape manufacturing method, etc., described in Japanese Patent Publication No. 56(1981)-26890.

Embodiments of the present invention and comparative examples will hereinafter be shown and the characteristics will be evaluated. Note that “parts” in the embodiments represent “weight parts.”

For the raw materials used in embodiments 1 to 6 and comparative examples 1 to 3, the abrasive is silica grains, which are colloidal silica (made by CATALYSTS & CHEMICALS INDUSTRIES). The average grain size is 12 nm. The binding agents are listed in Table 1. The treating agents (coupling agents) are listed in Table 2.

TABLE 1

| Binding | | |
|---|---|---|
| agent | Composition | Trade name |
| Resin A | Epoxy UV curing | Adeka: OPTOMER-KR |
| | Resin | |
| Resin B | Acrylic UV curing | DAINICHISEIKA COLOR & |
| | Resin | CHEMICALS: SEIKA BEAM |
| Resin C | Acrylic silicon | GE Toshiba silicones: UVHC |
| | UV curing resin | |
| Resin D | Polyester resin | TOYOBO: VYLON20SS |
| Resin E | Urethane resin | TOYOBO: UR8300 |

TABLE 2

| Treating | | |
|---|---|---|
| agent | Composition | Trade name |
| A | Silane coupling agent | Nippon Yunicar: A-172 |
| B | Titanate coupling | Nippon Soda: S-151 |
| | agent | |

Embodiment 1:

Materials with the following composition were put into a disperser in the order of a treating agent (coupling agent), an abrasive, and a binding agent, while being agitated. In the disperser, the materials were dispersed for 15 min, and a paint solution was generated. The paint solution has the following composition:

| | | |
|---|---|---|
| Abrasive: silica grains (average grain size 12 nm) | 10.0 | parts |
| Treating agent: treating agent A | 0.3 | parts |
| Binding agent: resin A | 3.0 | parts |
| Solvent: IPA | 86.7 | parts |
| Total | 100 | parts |

The lapping paint generated in the above-described procedure was formed on the supporting body of polyethylene terephthalate (PET) of 75 μm in thickness so that it had a thickness of 5 μm after drying. Next, it was dried with an oven by a hot wind of 115° C. for 60 seconds to volatilize the solvent. Thereafter, ultraviolet rays were irradiated at 120 W for 10 seconds to harden the binding agent. In this way, a lapping sheet sample was generated. The generated lapping sheet was cut into a circle of diameter 110 mm and fixed to a lapping machine (SII company). With the lapping machine, an optical fiber connector of 2.5 mmφ was lapped for 90 seconds. Thereafter, the return loss rate of the optical fiber, and a difference in level between the optical fiber end face and ferrule end face of the optical fiber connector, were measured.

Embodiment 2:

Using the resin B (binding agent) and the treating agent A, a lapping sheet was generated using the same procedure as that of embodiment 1.

Embodiment 3:

Using the resin C (binding agent) and the treating agent A, a lapping sheet was generated using the same procedure as that of embodiment 1.

Embodiment 4:

Using the resin A (binding agent) and the treating agent B, a lapping sheet was generated using the same procedure as that of embodiment 1.

Embodiment 5:

Using the resin B (binding agent) and the treating agent B, a lapping sheet was generated using the same procedure as that of embodiment 1.

Embodiment 6:

Using the resin C (binding agent) and the treating agent B, a lapping sheet was generated using the same procedure as that of embodiment 1.

### COMPARATIVE EXAMPLE 1

Using the resin D (binding agent) and with no treating agent, a lapping sheet was generated by heating and curing using the same procedure as that of embodiment 1 (but no irradiation of ultraviolet rays is performed).

### COMPARATIVE EXAMPLE 2

Using the resin E (binding agent) and with no treating agent, a lapping sheet was generated by heating and curing using the same procedure as that of embodiment 1 (but no irradiation of ultraviolet rays is performed).

### COMPARATIVE EXAMPLE 3

Using the resin A (binding agent) and with no treating agent, a lapping sheet was generated using the same procedure as that of embodiment 1.

Using the lapping sheet samples of the embodiments 1 to 6 and comparative examples 1 to 3, a lapping test was made. The lapping characteristics were evaluated by a method of evaluation which is to be described later. The results are listed in Table 3. In Table 3, “E1” represents embodiment 1 and “C1” represents comparative example 1.

TABLE 3

| | Light | | | | Separation | |
|---|---|---|---|---|---|---|
| | loss | Difference | Fiber end face | | of the | |
| | rate | in level | Lapping | | lapping | Overall |
| | dB | nm | scores | Cracks | layer | Evaluation |
| E1 | −62.6 | −0.8 | None | None | None | Good |
| E2 | −61.9 | +1.1 | None | None | None | Good |
| E3 | −63.1 | +10.3 | None | None | None | Good |
| E4 | −62.5 | −0.5 | None | None | None | Good |
| E5 | −61.7 | −9.8 | None | None | None | Good |
| E6 | −60.7 | −2.5 | None | None | None | Good |
| C1 | −37.4 | −45.3 | Many | None | None | Poor |
| C2 | −41.9 | −48.8 | Many | None | None | Poor |
| C3 | −58.2 | −39.1 | Many | None | None | Fair |

Method of Evaluation:

Each lapping sheet was mounted on a lapping machine. With the lapping machine, an optical fiber connector of 2.5 mm in diameter was lapped for 90 seconds while applying 2 ml of distilled water to the lapping sheet. After lapping, the optical fiber connector was washed and the connector end face was cleaned. Thereafter, the following evaluations were made.

For the lappingmachine, OFL-12 (SII company) was used. For the light loss rate, an inspecting machine RM3750B (JDS company) was used. At λ=1310 nm, the loss rate of the optical fiber was measured in dB. If a numerical value is lower, the loss is less and the transmission efficiency is higher. With a measuring machine ZX-1 MINI (Direct Optical Research Company), the difference in level between the optical fiber end face and the ferrule end face was measured in nm. The difference in level refers to the height of the center position of the optical fiber, measured from the center position of a virtual curved surface of the ferrule end face. The “+” in measured values means a protruding direction. A value close to ±0 is optimum. The external appearance of the fiber end face was visually observed by a microscope at 400× magnification. Lapping scores and cracks in the fiber end face were checked. For the separation of the lapping layer lapped, the separation of the lapping layer from the supporting body was checked after lapping (predetermined time). In the overall evaluation column, “Good” represents a case where there is no problem, “Fair” represents a case where the result of anyone of the above-described tests is bad, and “Poor” represents a bad case.

The embodiments 1 to 6 used a treating agent (coupling agent) and an ultraviolet-ray curing resin (monomer or oligomer). Because of this, as shown in Table 3, the dispersion of silica grains to the binding agent was good and there was no aggregation. The end face of the optical fiber connector was uniformly and accurately lapped. The light loss rate was a small value on the order of −60 dB. The difference in level was within an allowable range, and there were no lapping scores and cracks in the fiber end face. Thus, good optical characteristics were obtained. Furthermore, there was no separation of the lapping layer after lapping, and the durability of the lapping medium was good. The overall evaluations were “good”.

On the other hand, in the comparative examples 1 and 2, the lapping layer was formed by dispersing an abrasive to a binding agent (conventional high-polymer resin) without using a coupling agent. The comparative example 3 used an ultraviolet-ray curing resin (binding agent) but did not use a coupling agent. Because of this, the abrasive was not sufficiently dispersed. The light loss rate was high as compared with the above-described embodiments 1 to 6. For the difference in level, the optical fiber end face was concave with respect to the ferrule end face. There were a great number of scores in the fiber end face. Thus, the optical characteristics were inferior and the overall evaluation was poor.

While the present invention has been described with reference to the preferred embodiments thereof, the invention is not to be limited to the details given herein, but may be modified within the scope of the invention hereinafter claimed.

What is claimed is:

1. A lapping medium comprising:
a supporting body; and
a lapping layer formed on said supporting body and including both an abrasive, which comprises silica grains pretreated with at least one coupling agent selected from a group consisting of a silane coupling agent, a titanate coupling agent, and an aluminum-contained coupling agent, and a binder.

2. The lapping medium as set forth in claim 1, wherein said silica grains have an average grain size of 0.005 to 3 μm.

3. The lapping medium as set forth in claim 1, wherein said coupling agent is in the range of 0.1 to 10 weight parts to 100 weight parts of said silica grains.

4. The lapping medium as set forth in claim 1, wherein said binder is in the range of 10 to 200 weight parts to 100 weight parts of said abrasive.

5. The lapping medium as set forth in claim 1, wherein said binder comprises an ultraviolet-ray curing monomer, or an oligomer cured with ultraviolet rays.

6. A method of mirror-finishing a ferrule end face of an optical fiber connector with a lapping medium, said lapping medium comprising:
a supporting body; and
a lapping layer formed on said supporting body and including both an abrasive, which comprises silica grains pretreated with at least one coupling agent selected from a group consisting of a silane coupling agent, a titanate coupling agent, and an aluminum-contained coupling agent, and a binder.

7. The method as set forth in claim 6, wherein said silica grains have an average grain size of 0.005 to 3 μm.

8. The method as set forth in claim 6, wherein said coupling agent is in the range of 0.1 to 10 weight parts to 100 weight parts of said silica grains.

9. The method as set forth in claim 6, wherein said binder is in the range of 10 to 200 weight parts to 100 weight parts of said abrasive.

10. A method of generating a lapping medium, comprising the steps of:
preparing an abrasive comprising silica grains whose average grain size is 0.005 to 3 μm;
selecting at least one coupling agent from a group consisting of a silane coupling agent, a titanate coupling agent, and an aluminum-contained coupling agent;
adding said one coupling agent in the range of 0.1 to 10 weight parts to 100 weight parts of said abrasive;
preparing paint which has a mixture of said abrasive and a binder in the ratio of 100 to 200 weight parts to 100 weight parts of said abrasive and has a solid component of concentration 5 to 50 weight percent;
applying said paint to a supporting body;
drying said paint applied to said supporting body in the atmosphere of 100 to 130° C. and then irradiating ultraviolet rays to the dried paint to generate a lapping layer of 1 to 7 μm in thickness.
